(19) United States
(12) Patent Application Publication
(10) Pub. No.: US 2022/0261986 A1
(43) Pub. Date: Aug. 18, 2022

(54) DIAGNOSIS PATTERN GENERATION METHOD AND COMPUTER

(71) Applicant: Hitachi, Ltd., Tokyo (JP)

(72) Inventors: Takumi UEZONO, Tokyo (JP); Tadanobu TOBA, Tokyo (JP); Kenichi SHIMBO, Tokyo (JP); Hiroaki ITSUJI, Tokyo (JP)

(21) Appl. No.: 17/535,779

(22) Filed: Nov. 26, 2021

(30) Foreign Application Priority Data
Feb. 15, 2021 (JP) 2021-021893

(51) Int. Cl. G06T 7/00; G06V 10/82

(52) U.S. Cl. CPC G06T 7/0012; G06T 2207/20084; G06V 10/82

(57) ABSTRACT

An increase in a diagnosis load can be reduced. A diagnosis pattern generating unit generates a diagnosis pattern including a plurality of data sets for diagnosing whether a processing result of calculation processing by a subset of a plurality of intermediate nodes included in a learned neural network is correct. An intermediate node calculation component identifying unit identifies a node-core relationship that is a correspondence relationship between the intermediate node and a calculation component that executes calculation processing by the intermediate node. A diagnosis pattern reducing unit reduces the number of the plurality of data sets based on the node-core relationship.

### CROSS-REFERENCE TO RELATED APPLICATION

The present application claims priority from Japanese application JP 2021-021893, filed on Feb. 15, 2021, the contents of which is hereby incorporated by reference into this application.

### BACKGROUND OF THE INVENTION

### 1. Field of the Invention

The present disclosure relates to a diagnosis pattern generation method and a computer.

### 2. Description of the Related Art

In a system such as an autonomous driving system and an industrial infrastructure system, utilization of a complex system represented by artificial intelligence (AI) technology is also advancing for an edge device. Therefore, there are many edge devices including hardware such as a graphics processing unit (GPU) and a large scale integration (LSI) as an accelerator. In this type of edge device, an abnormality may occur in the hardware due to an influence of an environment, an aging degradation, or the like, and therefore, in order to ensure safety of the system and implement stable operation, it is important to perform diagnosis of the hardware.

A diagnosis method for diagnosing hardware includes

(*) a method of multiplexing hardware and comparing calculation results by each hardware,

(*) a method of comparing calculation results of a plurality of pieces of calculation processing performed using the same hardware,

(*) a method of checking whether original data is obtained by performing inverse operation on a calculation result,

(*) a method of periodically inputting a diagnosis pattern to a circuit to be diagnosed and comparing an output value of the circuit to be diagnosed with an expected value (LBIST: logic built-in self-test), and the like.

Further, WO2016/132468 (Patent Literature 1) discloses a diagnosis method of providing a restoration neural network that performs inverse operation on an identification neural network. In this diagnosis method, it is determined whether input data restored using the restoration neural network is within a range obtained by learning in advance, and hardware is diagnosed by evaluating, using a determination result of the determination, a determination result by the identification neural network.

In recent years, since a scale and complexity of the hardware to be diagnosed is increased, an increase in diagnosis load such as a diagnosis time, power consumption, and a circuit area of a diagnosis circuit becomes a problem in a diagnosis method in the related art.

For example, in the diagnosis method in which the hardware is multiplexed, the scale of the hardware increases, and thus power consumption and a circuit area increase. Therefore, in the edge device for which low power consumption, miniaturization, and the like are required, a desired specification may not be satisfied. Further, in the LBIST, the number of diagnosis patterns to be input is increased due to the complication of the circuit to be diagnosed, and a diagnosis load such as a diagnosis time, power consumption, and used memory capacity is increased.

In the technique described in Patent Literature 1, since a scale of the restoration neural network depends on a scale of the identification neural network, a diagnosis time, power consumption, a circuit area, and the like may increase due to an increase in the scale of the identification neural network.

### SUMMARY OF THE INVENTION

An object of the present disclosure is to provide a diagnosis pattern generation method and a computer capable of reducing a diagnosis load.

A diagnosis pattern generation method according to an aspect of the present disclosure is

a diagnosis pattern generation method for generating a diagnosis pattern for diagnosing a processor that executes calculation processing by a neural network using a plurality of calculation components, the diagnosis pattern generation method including:

(A) generating the diagnosis pattern including a plurality of data sets for diagnosing whether a processing result of calculation processing by a subset of a plurality of nodes included in the neural network is correct;

(B) identifying a node-core relationship that is a correspondence relationship between the node and the calculation component that executes calculation processing by the node; and

(C) reducing the number of the data sets based on the node-core relationship.

According to the present disclosure, the diagnosis load can be reduced.

### BRIEF DESCRIPTION OF THE DRAWINGS

FIG. 1 is a diagram showing a configuration example of a diagnosis point reducing system according to a first embodiment of the present disclosure.

FIG. 2 is a flowchart showing an example of reduction processing of a diagnosis pattern reducing unit.

FIG. 3 is a diagram showing an example of a hardware configuration of a cloud server.

FIG. 4 is a diagram showing a hardware configuration of an edge device.

FIG. 5 is a diagram showing a hardware configuration of a client computer.

FIG. 6 is a diagram showing a configuration example of a diagnosis point reducing system according to a second embodiment of the present disclosure.

FIG. 7 is a flowchart showing an example of processing performed by a diagnosis exclusion node identifying unit.

### DESCRIPTION OF THE PREFERRED EMBODIMENTS

Hereinafter, embodiments of the present disclosure will be described with reference to the drawings.

### First Embodiment

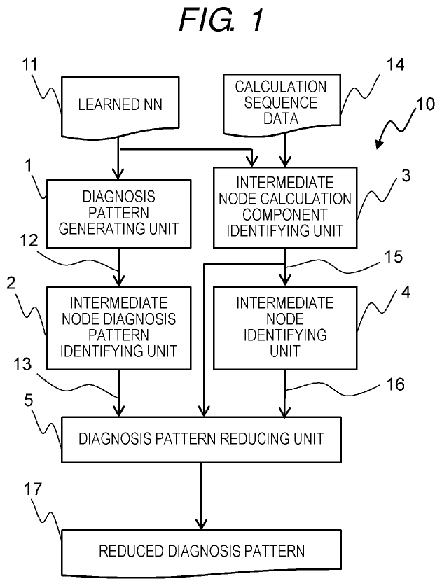

FIG. 1 is a diagram showing a configuration example of a diagnosis point reducing system according to a first embodiment of the present disclosure. A diagnosis point reducing system 10 shown in FIG. 1 includes a diagnosis pattern generating unit 1, an intermediate node diagnosis pattern identifying unit 2, an intermediate node calculation component identifying unit 3, an intermediate node identifying unit 4, and a diagnosis pattern reducing unit 5.

The diagnosis pattern generating unit 1 is a generating unit that generates, based on a learned neural network 11, a diagnosis pattern 12 for diagnosing a processor to be diagnosed and outputs the diagnosis pattern.

The learned neural network 11 is a neural network obtained by learning, and includes

(*) a plurality of nodes,

(*) a plurality of weight parameters set between the plurality of nodes, and

(*) a bias parameter set for each of the plurality of nodes. The learned neural network is shown as a learned NN in FIG. 1.

Specifically, the nodes include

(*) an input node that receives an input value,

(*) an output node that outputs an output value, and

(*) an intermediate node provided between the input node and the output node. Further, at least the intermediate node is plural.

The processor to be diagnosed is a processor that executes calculation processing by the learned neural network 11. In the present embodiment, the processor to be diagnosed is a graphics processing unit (GPU), and more specifically, is a multi-core GPU including a plurality of calculation components that perform the calculation processing. The calculation component is also referred to as a core. Further, the processor to be diagnosed is not limited to the GPU, and may be, for example, another device such as a field-programmable gate array (FPGA) or a general-purpose processor.

In the present embodiment, the diagnosis pattern 12 is a diagnosis pattern for an LBIST. As a generation method for generating the diagnosis pattern for the LBIST, a generation method for generating a diagnosis pattern for an LSI can be applied. For example, the diagnosis pattern generation unit 1 generates, as the diagnosis pattern 12, the diagnosis pattern for the LSI generated by replacing each node of the learned neural network 11 with a logic circuit equivalent to the node. In this case, the diagnosis pattern generating unit 1 can generate the diagnosis pattern 12 based on, for example, the weight parameters and the bias parameters which are included in the learned neural network 11.

For generating the diagnosis pattern for the LSI, for example, an existing tool such as an electronic design automation (EDA) tool or an existing test pattern generation algorithm such as a D algorithm can be used.

The diagnosis pattern 12 includes a plurality of data sets for diagnosing whether the calculation processing by each node (specifically, each intermediate node) of the learned neural network 11 is correct. It is not limited to diagnose whether the calculation processing of one intermediate node is correct with one data set, and in general, the entire calculation processing of the plurality of intermediate nodes can be diagnosed with one data set. Therefore, it can be said that each data set is used for diagnosing whether the calculation processing by one or more intermediate nodes included in a subset of a set including all the intermediate nodes is correct.

Further, the data set includes

(*) a diagnosis input value input to the learned neural network 11, and

(*) an expected value of an output value output from the learned neural network 11 when the diagnosis input value is input to the learned neural network 11.

The intermediate node diagnosis pattern identifying unit 2 identifies a node-data relationship that is a correspondence relationship between the data set included in the diagnosis pattern 12 and a diagnosable node that is an intermediate node whose calculation processing can be diagnosed as correct or not by the data set. The intermediate node diagnosis pattern identifying unit 2 generates and outputs an intermediate node diagnosis pattern data set 13 indicating the node-data relationship.

Examples of a method for determining the diagnosable node include a method using an error injection simulation.

When the error injection simulation is used, the intermediate node diagnosis pattern identifying unit 2 performs the following processing (A) to (C) for each combination of the data set and the intermediate node.

(A) Input processing. The input processing is processing of inputting an diagnosis input value of a target data set to the learned neural network 11 on an assumption that a failure (for example, a stuck-at failure) occurs in a target intermediate node.

(B) Comparison processing. The comparison process is processing of comparing an output value from the learned neural network 11 with an expected value of the target diagnosis pattern.

(C) Identifying processing. The identifying processing is processing of identifying the target intermediate node as the diagnosable node when the output value and the expected value do not match.

The intermediate node calculation component identifying unit 3 identifies, based on a calculation sequence data 14, a node-core relationship that is a correspondence relationship between the intermediate node of the learned neural network 11 and an execution component that is the calculation component that executes the calculation processing by the intermediate node.

Specifically, for each intermediate node of the learned neural network 11, the intermediate node calculation component identifying unit 3 identifies, from the calculation components of the processor to be diagnosed, the execution component that is the calculation component that executes the calculation processing of the intermediate node. The intermediate node calculation component identifying unit 3 generates and outputs execution component information 15 indicating the execution component for each intermediate node.

The calculation sequence data 14 indicates a processing order of the calculation processing by the learned neural network 11 and a correspondence relationship between the calculation processing and the calculation component that executes the calculation processing. The calculation sequence data is generated, for example, by compiling a program for executing the calculation processing by the learned neural network 11.

The intermediate node identifying unit 4 identifies, for each calculation component of the processor to be diagnosed, a calculation node that is the intermediate node corresponding to the calculation processing executed by the calculation component. Then, the intermediate node identifying unit 4 generates and outputs calculation node information 16 indicating the calculation node for each calculation component.

When the execution component information 15 is table data with the intermediate node as a key and the calculation component as a value, the processing performed by the intermediate node identifying unit 4 is equivalent to processing of generating table data with the calculation component as the key and the intermediate node as the value by interchanging the key and the value.

The diagnosis pattern reducing unit 5 reduces the number of the data sets included in the diagnosis pattern 12 based on the intermediate node diagnosis pattern data set 13, the execution component information 15, and the calculation node information 16. Then, the diagnosis pattern reducing unit 5 generates and outputs the diagnosis pattern in which the number of the data sets is reduced as a reduced diagnosis pattern 17.

The diagnosis pattern reducing unit 5 reduces the number of the data sets by taking diagnosis of whether the calculation processing of at least one calculation node among the calculation nodes corresponding to the calculation components is correct as a fact that it can be regarded that whether the calculation processing of all the calculation nodes corresponding to the calculation components is correct is diagnosed. Accordingly, a diagnosis load related to the diagnosis can be reduced while reducing a decrease in accuracy of the diagnosis.

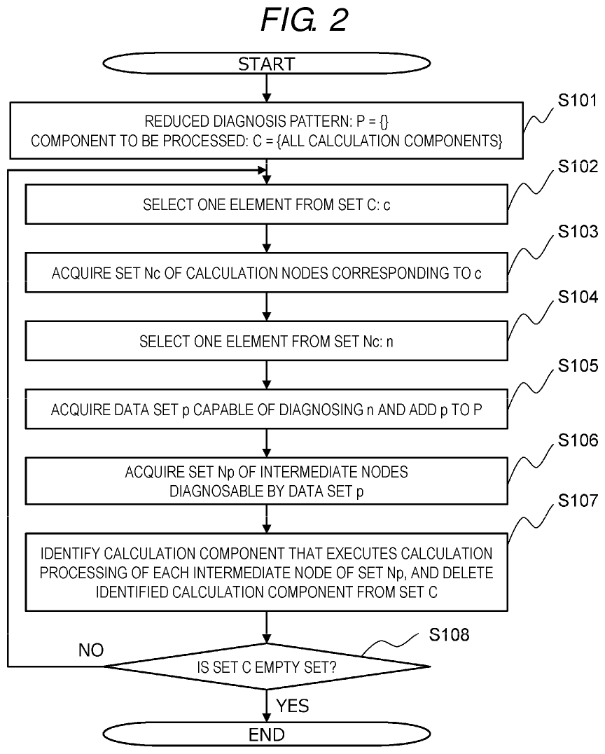

FIG. 2 is a flowchart showing an example of reduction processing performed by the diagnosis pattern reducing unit 5.

In the reduction processing, the diagnosis pattern reducing unit 5 first initializes a reduced diagnosis pattern P to an empty set (P={ }). Further, the diagnosis pattern reducing unit 5 initializes elements of a component set to be processed C to all the calculation components of the processor to be diagnosed (C={all the calculation components}) (step S101).

The diagnosis pattern reducing unit 5 selects any one of the calculation components, which are the elements of the component set to be processed C, as a calculation component c (step S102).

The diagnosis pattern reducing unit 5 acquires a set Nc of calculation nodes corresponding to the calculation component c based on the calculation node information 16 (step S103). Specifically, the calculation nodes corresponding to the calculation components c are intermediate nodes corresponding to calculation processing executed by the calculation component c.

The diagnosis pattern reducing unit 5 selects any one of the calculation nodes that are elements from the set Nc of the calculation nodes as a calculation node n (step S104). A method for selecting the calculation node n is not particularly limited. For example, the diagnosis pattern reducing unit 5 can randomly select the calculation node n from the set Nc of calculation nodes.

Based on the intermediate node diagnosis pattern data set 13, the diagnosis pattern reducing unit 5 acquires, as a diagnosis data set p, a data set with which whether the calculation processing of the calculation node n is correct can be diagnosed, and adds the diagnosis data set p to the reduced diagnosis pattern P (step S105).

Based on the intermediate node diagnosis pattern data set 13, the diagnosis pattern reducing unit 5 acquires a set Np of diagnosis nodes that are intermediate nodes capable of diagnosing whether the calculation processing is correct with the diagnosis data set p (step S106). The set Np of the diagnosis nodes also includes the above-described calculation node n.

Based on the execution component information 15, the diagnosis pattern reducing unit 5 identifies a calculation component that executes calculation processing of each diagnosis node included in the set Np of the diagnosis nodes, and deletes the identified calculation component from the component set to be processed C (step S107).

The diagnosis pattern reducing unit 5 determines whether the component set to be processed Cis an empty set (step S108). When the component set to be processed C is not an empty set, the diagnosis pattern reducing unit 5 returns to the processing of step S102, and when the component set to be processed C is an empty set, the diagnosis pattern reducing unit 5 ends the processing.

As described above, according to the present embodiment, the diagnosis pattern generating unit 1 generates the diagnosis pattern including the plurality of data sets for diagnosing whether the processing result of the calculation processing by the subset of the plurality of intermediate nodes included in the learned neural network 11 is correct. The intermediate node calculation component identifying unit 3 identifies the node-core relationship that is the correspondence relationship between the intermediate node and the calculation component that executes the calculation processing by the intermediate node. The diagnosis pattern reducing unit 5 reduces the number of the plurality of data sets based on the node-core relationship. Therefore, the diagnosis load related to the diagnosis can be reduced while reducing the decrease in the accuracy of the diagnosis.

Further, in the present embodiment, for each calculation component, the data set with which whether the calculation processing of any intermediate node of the intermediate nodes corresponding to the calculation component is correct can be diagnosed is selected. By deleting the data set other than the selected data set for each calculation component, the number of the data sets is reduced. Therefore, an increase in the diagnosis load can be reduced while reducing the decrease in the accuracy of the diagnosis.

Further, in the present embodiment, based on the diagnosis input value and the expected value which are included in the data set, the data set with which whether the calculation processing of each intermediate node corresponding to the calculation component is correct can be diagnosed is identified. Therefore, a decrease in the accuracy of the diagnosis can be more appropriately reduced.

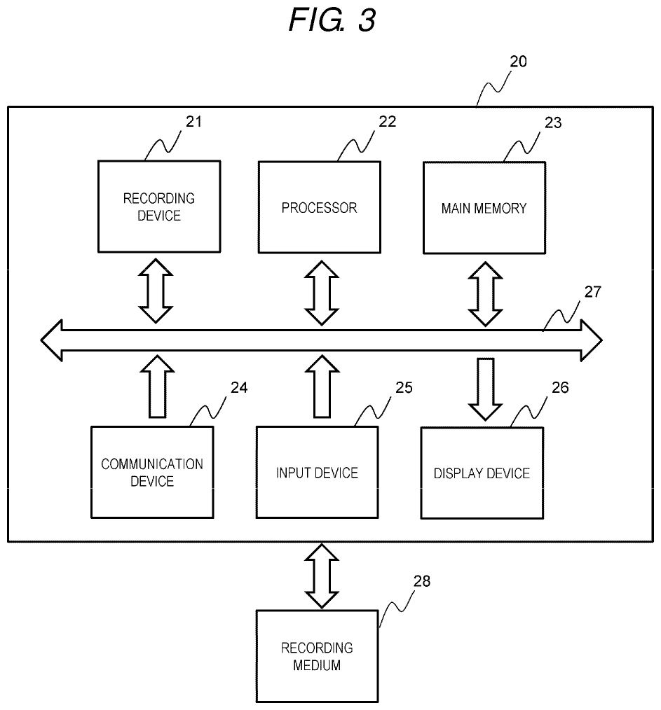

FIG. 3 is a diagram showing a hardware configuration example of a cloud server that is an example of a computer implementing the diagnosis point reducing system 10 shown in FIG. 1.

A cloud server 20 shown in FIG. 3 includes a recording device 21, a processor 22, a main memory 23, a communication device 24, an input device 25, and a display device 26, which are connected to each other via a bus 27.

The recording device 21 records data in a writable and readable manner, and records various data such as a program for defining an operation of the processor 22, the learned neural network 11, and the calculation sequence data 14. The processor 22 reads the program recorded in the recording device 21 to the main memory 23, and executes processing according to the program using the main memory 23, thereby implementing the units 1 to 5 of the diagnosis point reducing system 10 shown in FIG. 1. It is considered that examples of the processor 22 include a CPU or a GPU, and other semiconductor devices may be used as long as the semiconductor devices execute predetermined processing.

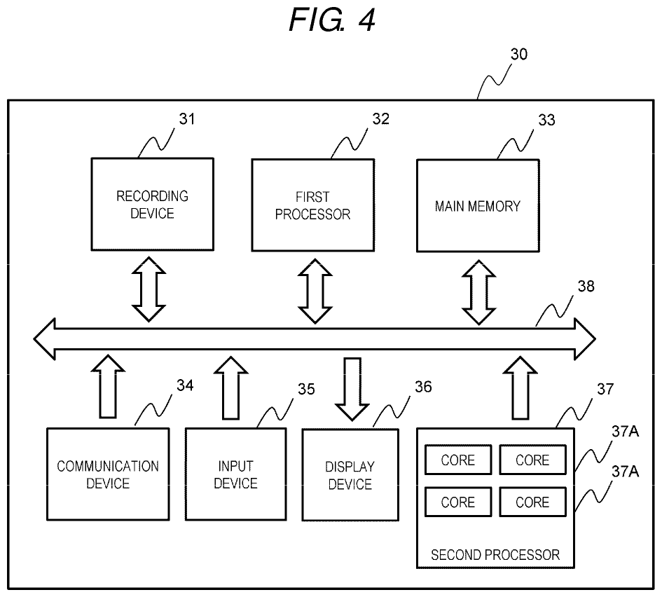

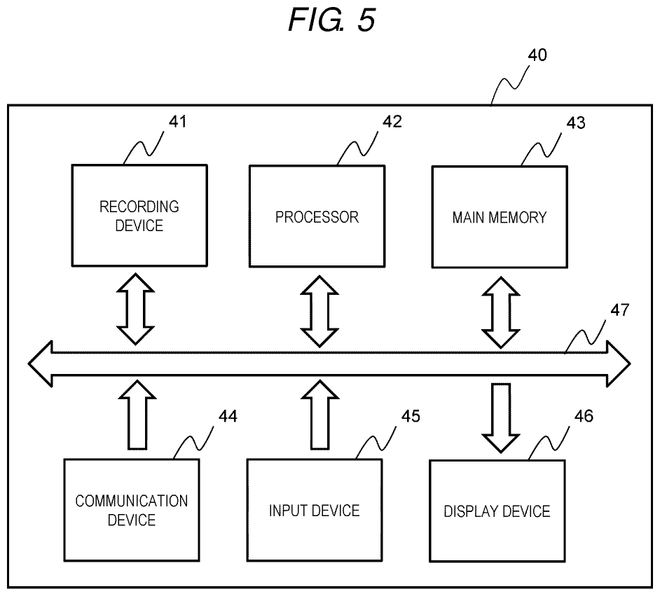

The communication device 24 is communicably connected to an external device such as an edge device 30 and a client computer 40 shown in FIGS. 4 and 5 to be described later, and transmits and receives information to and from the external device. The input device 25 receives various kinds of information from a user of the cloud server 20. The display device 26 displays the various kinds of information.

With the configuration described above, the processor 22 can distribute the reduced diagnosis pattern 17 generated by the diagnosis point reducing system 10 to the edge device 30 via the communication device 24. At this time, the processor 22 may distribute the reduced diagnosis pattern 17 together with a learned neural network program that is a program for causing the processor to execute the calculation processing of the learned neural network 11. A timing at which the reduced diagnosis pattern 17 is distributed is, for example, a timing at which the learned neural network program is updated.

The program for defining the operation of the processor 22 may be recorded in a recording medium 28 that non-temporarily stores the data, such as a semiconductor memory, a magnetic disk, an optical disk, a magnetic tape, or a magneto-optical disk. In this case, the cloud server 20 reads the program recorded in the recording medium 28 and executes processing according to the read program, thereby implementing the units 1 to 5 of the diagnosis point reducing system 10 shown in FIG. 1. The recording medium 28 may be provided in the cloud server 20.

FIG. 4 is a diagram showing a hardware configuration example of the edge device that is an example of the computer that performs the diagnosis using the reduced diagnosis pattern 17 generated by the diagnosis point reducing system 10. The edge device 30 shown in FIG. 4 is, for example, an electronic control unit (ECU). The edge device 30 may be mounted on, for example, a vehicle such as an automobile.

The edge device 30 shown in FIG. 4 includes a recording device 31, a first processor 32, a main memory 33, a communication device 34, an input device 35, a display device 36, and a second processor 37, which are connected to each other via a bus 38.

The recording device 31 records data in a writable and readable manner and records various data such as a program for defining an operation of the first processor 32, and a learned neural network program and the reduced diagnosis pattern 17 for defining an operation of the second processor 37.

The learned neural network program is a program for executing the calculation processing of the learned neural network 11 shown in FIG. 1.

The first processor 32 reads the program recorded in the recording device 21 to the main memory 33, and executes processing according to the program using the main memory 33. It is considered that examples of the first processor 32 include a CPU or a GPU, and other semiconductor devices may be used as long as the semiconductor devices execute predetermined processing.

The communication device 34 is communicably connected to the external device such as the cloud server 20 shown in FIG. 3, and transmits and receives information to and from the external device. For example, the communication device 34 receives the learned neural network program, the reduced diagnosis pattern 17, and the like from the cloud server 20. The learned neural network program and the reduced diagnosis pattern 17 received by the communication device 34 are stored in the recording device 31, for example, via the first processor 32.

The input device 35 receives various kinds of information from a user of the edge device 30. The display device 36 displays the various kinds of information.

The second processor 37 is a hardware accelerator that executes predetermined calculation processing. More specifically, the second processor 37 is an example of a target processor that executes the calculation processing by the learned neural network 11 in accordance with the learned neural network program.

In the present embodiment, the second processor 37 is the multi-core GPU. The second processor 35 includes a plurality of cores 35A that area plurality of calculation components for performing the calculation processing. In the example of FIG. 4, four cores 35A are shown, whereas the number of the cores 35A is not limited to four and may be two or more.

The first processor 32 executes the following processing (1) and (2).

(1) Executing processing. The executing processing is processing of causing the second processor 37 to read the learned neural network program and execute the calculation process by the learned neural network 11.

(2) Diagnosis Processing. The diagnosis processing is processing of diagnosing the second processor 37 by causing the second processor 37 to load the reduced diagnosis pattern 17 at a predetermined timing.

The calculation processing by the learned neural network 11 in the executing processing (1) is, for example, processing of generating control information for controlling a predetermined machine. In this case, the first processor 32 alternately executes the execution processing (1) and machine control processing for controlling the predetermined machine based on the control information that is a processing result of the calculation processing by the learned neural network 11. Further, the first processor 32 executes the diagnosis processing (2) during the execution of the machine control processing.

The predetermined machine is, for example, a vehicle on which the edge device 30 is mounted. The machine control processing is, for example, processing related to automatic driving control of the vehicle. The automatic driving control includes a brake control, an accelerator control, and the like.

As described above, according to the present embodiment, the first processor 32 diagnoses the second processor 37 based on the reduced diagnosis pattern 17. Therefore, the increase in the diagnosis load can be reduced.

In the present embodiment, the first processor 32 diagnoses the second processor 37 during the execution of the machine control processing. Therefore, the second processor 37 can be diagnosed without stopping the calculation processing by the learned neural network 11.

FIG. 5 is a diagram showing an example of a hardware configuration of the client computer capable of communicating with the cloud server 20.

The client computer 40 shown in FIG. 5 includes a recording device 41, a processor 42, a main memory 43, a communication device 44, an input device 45, and a display device 46, which are connected to each other via a bus 47.

The recording device 41 records data in a writable and readable manner, and records various data such as a program for defining an operation of the processor 42. The processor 42 reads the program recorded in the recording device 41 to the main memory 43, and executes processing according to the program using the main memory 43. It is considered that examples of the processor 42 include a CPU or a GPU, and other semiconductor devices may be used as long as the semiconductor devices execute predetermined processing.

For example, the communication device 44 is communicably connected to the external device such as the cloud server 20 shown in FIG. 3 described above, and transmits and receives information to and from the external device. The input device 45 receives various kinds of information from a user of the client computer 40. The display device 46 displays the various kinds of information.

For example, the processor 42 performs generation request processing for requesting the generation of the reduced diagnosis pattern 17 based on a pattern generation instruction received via the input device 45. For example, the processor 42 transmits a generation request for requesting the generation of the reduced diagnosis pattern 17 to the cloud server 20. For example, when the cloud server 20 receives the generation request, the cloud server 20 generates the reduced diagnosis pattern 17 as described with reference to FIGS. 1 to 3, and transmits a display request for requesting display of the reduced diagnosis pattern 17 to the client computer 40.

For example, the processor 42 performs display processing for displaying the reduced diagnosis pattern 17 based on a display instruction received from the cloud server 20 via the communication device 44. For example, the processor 42 displays a Web screen indicating the reduced diagnosis pattern 17 on the display device 26.

### Second Embodiment

The present embodiment describes an example in which reduction of a diagnosis pattern is performed based on an influence degree of an output value of each intermediate node on a calculation result of a learned neural network.

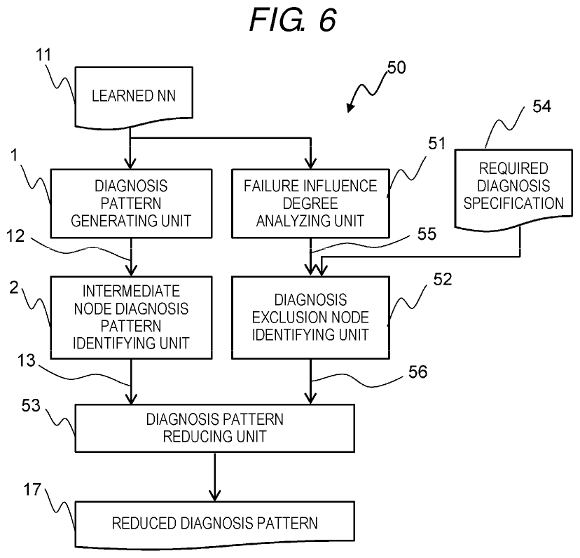

FIG. 6 is a diagram showing a configuration example of a diagnosis point reducing system according to a second embodiment of the present disclosure. As compared with the diagnosis point reducing system 10 according to the first embodiment shown in FIG. 1, a diagnosis point reducing system 50 shown in FIG. 6 is different in that the diagnosis point reducing system 50 includes a failure influence degree analyzing unit 51, a diagnosis exclusion node identifying unit 52, and a diagnosis pattern reducing unit 53 instead of the intermediate node calculation component identifying unit 3, the intermediate node identifying unit 4, and the diagnosis pattern reducing unit 5. Further, instead of the calculation sequence data 14, a required diagnosis specification 54 is input to the diagnosis point reducing system 50.

The failure influence degree analyzing unit 51 calculates, based on the learned neural network 11, a failure influence degree, which is the influence degree of the output value of each intermediate node on the calculation result of the learned neural network 11. The failure influence degree analyzing unit 51 generates and outputs influence degree data 55 indicating the failure influence degree for each intermediate node.

In the present embodiment, for example, the failure influence degree analyzing unit 51 calculates, as the failure influence degree, an index called architeral vulnability factor (AVF) for each intermediate node of the learned neural network 11 by using error injection simulation.

The AVF is defined by an error rate of the calculation result of the learned neural network 11 when an all-failure mode occurs in the intermediate node. The all-failure mode is a mode in which all bits of the output value of the intermediate node are erroneous. The error rate of the calculation result is a ratio of an error bit to all bits of the calculation result. An error of the bit means that a value of the bit is different from an expected value. For example, when the calculation result is 64 bits, 50 bits of the calculation result match the expected values, and 14 bits of the calculation result are different from the expected values, the AVF is 14/64.

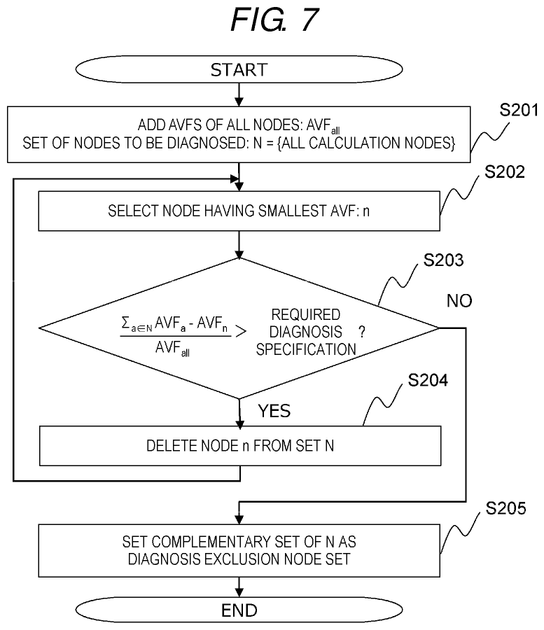

The diagnosis exclusion node identifying unit 52 identifies, based on the required diagnosis specification 54 and the influence degree data 55, diagnosis exclusion nodes other than diagnosis nodes to be diagnosed among the intermediate nodes. Then, a set of the diagnosis exclusion nodes is generated and output as a diagnosis exclusion node set 56. Processing of the diagnosis exclusion node identifying unit 52 will be described later with reference to FIG. 7.

The required diagnosis specification 54 indicates a constraint condition related to accuracy of the diagnosis required by a user. In the present embodiment, the required diagnosis specification 54 is a threshold for a diagnosis coverage ratio C to be described later.

The diagnosis pattern reducing unit 53 generates and outputs the reduced diagnosis pattern 17 based on the intermediate node diagnosis pattern data set 13 and the diagnosis exclusion node set 56.

Specifically, the diagnosis pattern reducing unit 53 performs the following processing (a) to (c).

(a) Identifying processing. The identifying processing is processing of identifying, based on the intermediate node diagnosis pattern data set 13, a data set with which only whether calculation processing of the diagnosis exclusion node included in the diagnosis exclusion node set 56 is correct can be diagnosed as an exclusion data set.

(b) Reducing processing. The reducing processing is processing of reducing the number of data sets included in the diagnosis pattern 12 by excluding the exclusion data set from the diagnosis pattern 12.

(c) Generating processing. The generating processing is processing of generating and outputting a diagnosis pattern obtained by reducing the number of the data sets as the reduced diagnosis pattern 17.

FIG. 7 is a flowchart showing an example of the processing of the diagnosis exclusion node identifying unit 52.

First, the diagnosis exclusion node identifying unit 52 calculates, based on the influence degree data 55, a total value AVFₐₗₗ obtained by adding AVFs of all the intermediate nodes. Then, the diagnosis exclusion node identifying unit 52 initializes a set of nodes to be diagnosed N to all the intermediate nodes (N={all the calculation nodes}) (step S201).

The diagnosis exclusion node identifying unit 52 selects an intermediate node having a smallest AVF as an intermediate node n from the set of nodes to be diagnosed N (step S202).

The diagnosis exclusion node identifying unit 52 calculates the diagnosis coverage ratio C of the set of nodes to be diagnosed N based on an AVFₙ that is an AVF of the intermediate node n, and determines whether the diagnosis coverage ratio C is larger than the required diagnosis specification 54 (step S203).

The diagnosis coverage ratio C is expressed by the following equation (1).

$$C = \frac{{Σ}_{a ∈ N} {AVF}_{a} - {AVF}_{n}}{{AVF}_{all}}$$

Here, a is an intermediate node as an element of the set of nodes to be diagnosed N, AVFₐ is an AVF of the intermediate node a, and AVF_{N} is an AVF of the selected intermediate node n.

When the diagnosis coverage ratio C is larger than the required diagnosis specification 54, the diagnosis exclusion node identifying unit 52 deletes the intermediate node n from the set of nodes to be diagnosed N (step S204), and returns to processing of step S202.

When the diagnosis coverage ratio C is equal to or less than the required diagnosis specification 54, the diagnosis exclusion node identifying unit 52 generates and outputs a complementary set of the set of nodes to be diagnosed N as the diagnosis exclusion node set 56 (step S205), and ends the processing.

Hardware configurations of the cloud server 20, the edge device 30, and the client computer 40 are similar to those in the first embodiment.

As described above, according to the present embodiment, the number of the data sets included in the diagnosis pattern is reduced based on the failure influence degree that is the influence degree of the output value of each intermediate node on the calculation result of the learned neural network 11. Therefore, the diagnosis load related to the diagnosis can be reduced while reducing a decrease in accuracy of the diagnosis.

According to the present embodiment, since the failure influence degree is the AVF, the influence of the output value of each intermediate node on the calculation result of the learned neural network 11 can be appropriately reflected.

Further, according to the present embodiment, when the diagnosis coverage ratio C is equal to or less than the threshold, the data set with which only whether the calculation processing of the intermediate nodes included in the complementary set of the diagnosis exclusion node set 56 is correct can be diagnosed is deleted. Therefore, the diagnosis load related to the diagnosis can be reduced while reducing the decrease in accuracy of the diagnosis.

The embodiments of the present disclosure described above are examples for the purpose of explaining the present disclosure, and the scope of the present disclosure is not intended to be limited only to those embodiments. A person skilled in the art could have implemented the present disclosure in various other embodiments without departing from the scope of the disclosure.

What is claimed is:

1. A diagnosis pattern generation method for generating a diagnosis pattern for diagnosing a processor that executes calculation processing by a neural network using a plurality of calculation components, the diagnosis pattern generation method comprising:
(A) generating the diagnosis pattern including a plurality of data sets for diagnosing whether a processing result of calculation processing by a subset of a plurality of nodes included in the neural network is correct;
(B) identifying a node-core relationship that is a correspondence relationship between the node and the calculation component that executes calculation processing by the node; and
(C) reducing the number of the data sets based on the node-core relationship.

2. The diagnosis pattern generation method according to claim 1, wherein
the (C) includes:
(C1) identifying, for each of the calculation components, a set of the nodes corresponding to the calculation component based on the node-core relationship;
(C2) selecting, for each of the calculation components, the data set with which whether calculation processing of any of the nodes included in the set is correct is diagnosed; and
(C3) reducing, for each of the calculation components, the number of the data sets by deleting the data set other than the acquired data set.

3. The diagnosis pattern generation method according to claim 2, wherein
the data set includes:
(X1) a diagnosis input value to be input to the neural network; and
(X2) an expected value of an output value output from the neural network when the diagnosis input value is input to the neural network, and
the (C2) includes:
(C21) specifying, based on the diagnosis input value and the expected value, a node-data relationship that is a correspondence relationship between the data set and the node configured to diagnose whether calculation processing is correct with the data set; and
(C22) selecting any one of the data sets based on the node-data relationship.

4. A diagnosis pattern generation method for generating a diagnosis pattern for diagnosing a processor that executes calculation processing by a neural network using a plurality of calculation components, the diagnosis pattern generation method comprising:
(A) generating the diagnosis pattern including a plurality of data sets for diagnosing whether a processing result of calculation processing by a subset of a plurality of nodes included in the neural network is correct;
(B) calculating an influence degree of an output value of each node on a calculation result of the neural network; and
(C) reducing the number of the data sets based on the influence degree.

5. The diagnosis pattern generation method according to claim 4, wherein
the influence degree is an architeral vulnability factor (AVF) that is a ratio of an error bit to all bits of the calculation result when all bits of the output value of the node are error.

6. The diagnosis pattern generation method according to claim 5, wherein
the (C) includes:
(C1) selecting a node from a set including each node in an ascending order of the AVF, and deleting the selected node from the set when a diagnosis coverage ratio by the set is larger than a threshold; and
(C2) when the diagnosis coverage ratio is equal to or less than the threshold, reducing the number of the data sets by deleting a data set with which only whether calculation processing of a node included in a complementary set of the set is correct is diagnosed, and
the diagnosis coverage ratio is expressed by the following equation (1),
$$C = \frac{{Σ}_{a ∈ N} {AVF}_{a} - {AVF}_{n}}{{AVF}_{all}}$$
in which AVFₐₗₗ is a sum of the influence degrees of all the nodes, N is a set, a is a node as an element of the set, AVFₐ is an AVF of the node a, and AVF_{N} is an AVF of a selected node n.

7. A computer comprising:
a first processor;
a second processor including a plurality of calculation components configured to perform calculation processing; and
a storage unit, wherein
the storage unit stores
(A) a neural network program for causing the second processor to execute calculation processing of the neural network, and
(B) the diagnosis pattern in which the number of the data sets is reduced by the diagnosis pattern generation method according to claim 1, and
the first processor is configured to
(1) cause the second processor to read the neural network program and execute the calculation processing, and
(2) cause the second processor to load the diagnosis pattern at a predetermined timing to diagnose the second processor.

8. The computer according to claim 7, wherein
the first processor is configured to
in the (1), alternately execute processing of causing the second processor to execute the calculation processing and machine control processing of controlling a predetermined machine based on a processing result of the calculation processing, and
in the (2), diagnose the second processor during the execution of the machine control processing.
